(19) United States
(12) Patent Application Publication
(10) Pub. No.: US 2014/0372989 A1
(43) Pub. Date: Dec. 18, 2014

(54) IDENTIFICATION OF A FAILED CODE CHANGE

(71) Applicants: Inbar Shani, Kibutz Beit Kama (IL); Amichai Nilsan, Rehovot (IL); IIan Shufer, Tel Aviv (IL)

(72) Inventors: Inbar Shani, Kibutz Beit Kama (IL); Amichai Nilsan, Rehovot (IL); IIan Shufer, Tel Aviv (IL)

(21) Appl. No.: 14/374,249

(22) PCT Filed: Jan. 31, 2012
(86) PCT No.: PCT/US12/23344

§ 371 Date: Jul. 24, 2014

(51) Int. Cl. G06F 11/36; G06F 9/44

(52) U.S. Cl. CPC G06F 11/3688; G06F 8/70
USPC 717/131

(57) ABSTRACT

A method to identify a failed code change in a deployment pipeline with a plurality of code changes. The plurality of code changes are tested by running a set of tests on the plurality of code changes until a subset of the plurality of code changes pass the set of tests. Each time the subset fails the set of tests, at least one of the plurality of code changes is removed from the subset. The failed code change is determined based on the subset that passes the set of tests.

### BACKGROUND

Software development life cycles use continuous integration (CI) and continuous deployment (CD) to reduce the time code changes spend in a production line. Continuous integration automates the process of receiving code changes from a specific source configuration management (SCM) tool, constructing deliverable assemblies with the code changes, and testing the assemblies.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a network environment according to an example;

FIGS. 2-3 illustrate block diagrams of systems to identify a failed code change in a deployment pipeline according to examples;

FIG. 4 illustrates a block diagram of a computer readable medium useable with a system, according to an example;

FIG. 5 illustrates a schematic diagram of a process that identifies a failed code change in a deployment pipeline according to an example; and

FIGS. 6-7 illustrate flow charts of methods to identify a failed code change in a deployment pipeline according to examples.

### DETAILED DESCRIPTION

In the following detailed description, reference is made to the accompanying drawings which form a part hereof, and in which is illustrated by way of specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Continuous integration (CI) and continuous deployment (CD) automate the construction, testing, and deployment of code assemblies with a code change. The automation begins after a code change is committed to a source configuration management (SCM) tool. Continuous integration automates the process of retrieving code changes from the SCM tool, constructing deliverable assemblies, such as executing a build and unit testing the assemblies. Continuous deployment extends continuous integration by automatically deploying the assemblies into a test environment and executing testing on the assemblies. Continuous integration facilitates on-going integration of code changes by different developers, and reduces the risk of failures in the test environment due to code mergers.

In examples, a method to identify a failed code change in a deployment pipeline with a plurality of code changes is provided. The plurality of code changes are tested by running a set of tests on the plurality of code changes until a subset of the plurality of code changes pass the set of tests. Each time the subset fails the set of tests, at least one of the plurality of code changes is removed from the subset. The failed code change is determined based on the subset that passes the set of tests.

The phrase “code change” refers to a change in the source code for a software application. The phrase code change may also refer to a code change that is part of a code assembly constructed as part of a continuous integration process.

The phrase “deployment pipeline” refers to a set of actions executed serially and/or in parallel on a queue of code changes. For example, the deployment pipeline may include building the code, executing unit tests, deploying the code, running automated tests, staging the code, running end-to-end tests and deploying the code to production.

The phrase “set of tests” refers to the tests run in a simulated environment using the code changes. The set of tests may include unit tests to test integration of the code changes and/or functionality tests with the code change,

The phrase “failed code change” refers to a failure of at least one code change during testing. For example, a plurality of code changes may be assembled or built into an assembly and unit tests may be performed on the code changes. The unit test may fail if one code change has an error and/or if the combinations of code changes do not work properly together.

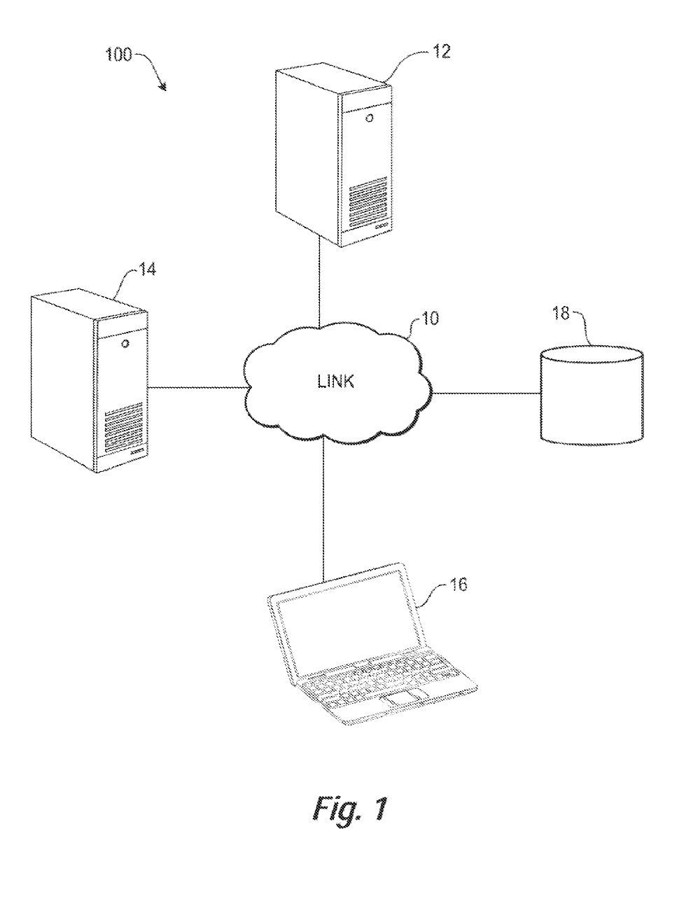

FIG. 1 illustrates a network environment 100 according to an example. The network environment 100 includes a link 10 that connects a test device 12, a deployment device 14, a client device 16, and a data store 18. The test device 12 represents generally any computing device or combination of computing devices that test a plurality of code changes from a deployment device 14. The deployment device 14 represents a computing device that receives the code changes and deploys code changes in the deployment pipeline.

The client device 16 represents a computing device and/or a combination of computing devices configured to interact with the test device 12 and the deployment device 14 via the link 10. The interaction may include sending and/or transmitting data on behalf of a user, such as the code change. The interaction may also include receiving data, such as a software application with the code changes. The client device 16 may be, for example, a personal computing device which includes software that enables the user to create and/or edit code for a software application.

The test device 12 may run a set of tests on the plurality of code changes in an application under test environment to integrate the plurality of code changes for use in a software application. The set of tests and/or the code changes may be stored in the data store 18. The data store 18 represents generally any memory configured to store data that can be accessed by the test device 12 and the deployment device 14 in the performance of its function. The test device 12 functionalities may be accomplished via the link 10 that connects the test device 12 to the deployment device 14, the client device 16, and the data store 18.

The link 10 represents generally one or more of a cable, wireless, fiber optic, or remote connections via a telecommunication link, an infrared link, a radio frequency link, or any other connectors or systems that provide electronic communication. The link 10 may include, at least in part, an intranet, the Internet, or a combination of both. The link 10 may also include intermediate proxies, routers, switches, load balancers, and the like.

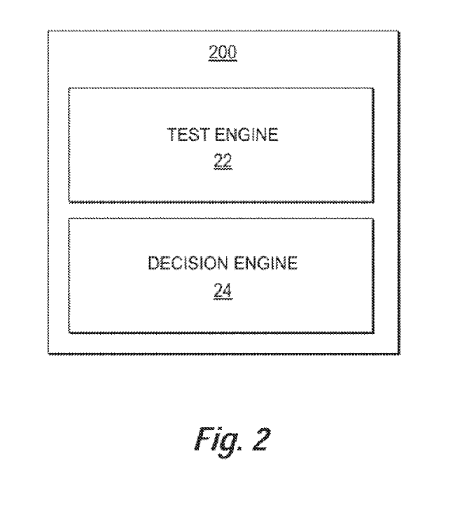

FIG. 2 illustrates a block diagram of a system 100 to identify a failed code change in a deployment pipeline with a plurality of code changes. Referring to FIG. 2, the system 200 includes a test engine 22 and a decision engine 24. The test engine 22 represents generally a combination of hardware and/or programming that performs a set of tests on a subset of the plurality of code changes in the deployment pipeline. The decision engine 24 represents generally a combination of hardware and/or programming that determines the failed code change. The decision engine 24 also instructs the test engine 22 to perform the set of tests and removes at least one of the plurality of code changes from the subset until the subset passes the set of tests. The decision engine 24 determines the failed code change based on the at least one code change removed from the subset that passes the set of tests.

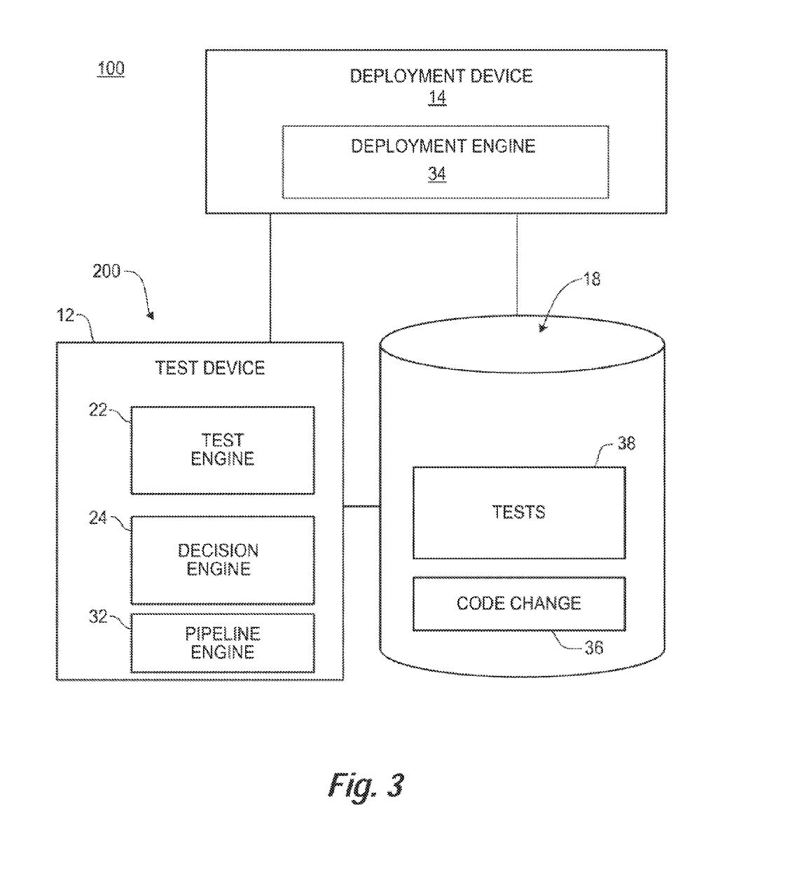

FIG. 3 illustrates a block diagram of the system 200 in a network environment 100 according to a further example. The system 200 illustrated in FIG. 3 includes the test device 12, the deployment device 14 and the data store 18. The test device 12 is illustrated as including a test engine 22 and a decision engine 24. The test device 12 is connected to the deployment device 14, which receives the code change 36 from the client device 16. The code change 36 is tested in the test device 12 using the tests or set of tests 38 from the data store 18. The deployment device 14 deploys the tested code change 36 via a deployment pipeline after the code changes pass the set of tests 38.

The test engine 22 performs a set of tests 38 on a subset of the plurality of code changes 36 in the deployment pipeline. The decision engine 24 instructs the test engine 22 to perform the set of tests 38. The decision engine 24 also removes at least one of the plurality of code changes 36 from the subset of the plurality of code changes 36 until the subset passes the set of tests 38. The decision engine 24 may have the capability to remove the code changes 36 and/or may instruct a separate engine, such as the pipeline engine 32 (discussed below) to remove the code changes 36.

Furthermore, the decision engine 24 determines the failed code changes based on the at least one code change 36 removed from the subset that passes the set of tests 38. For example, the decision engine 24 may identify at least one of the plurality of code changes 36 removed from the subset to determine the failed code change. Moreover, the decision engine 24 may perform a comparison. For example, when the subset fails the set of tests 38 prior to passing the set of tests 38, the decision engine 24 may determine the failed code by comparing the at least one code change 36 contained in the subset that passes the set of tests 38 and the at least one code change 36 contained the subset that fails the set of tests 38. The decision engine 24 may also automatically transmit a message identifying the failed code change.

The test device 12 is further illustrated to include a pipeline engine 32. The pipeline engine 32 represents generally a combination of hardware and/or programming that creates a subset of the plurality of code changes 36 in the deployment pipeline and/or removes the at least one of the plurality of code changes from the subset. For example, the pipeline engine 32 may receive instructions from the decision engine 24 to remove the at least one of the plurality of code changes 36. The pipeline engine 32 may also create a plurality of parallel test subsets from the plurality of code changes 36. Each of the plurality of parallel test subsets include a distinct permutation of the plurality of code changes 36. The test engine 22 may test each of the plurality of parallel test subsets simultaneously to determine which of the plurality of parallel test subsets pass the set of tests 38. Simultaneous testing may be performed based on the capabilities of the processor and/or computing resources.

The deployment device 14 includes a deployment engine 34. The deployment engine 34 represents generally a combination of hardware and/or programming that deploys the code change 36 after testing in an application under test environment. The deployment device 14 is connected to the data store 18. The data store 18 is, for example, a database that stores code changes 36 and the set of tests 38. The deployment engine 34 may work together with the test engine 22, the decision engine 24, and the pipeline engine 36 to test the integration of plurality of code changes 36 in the deployment pipeline.

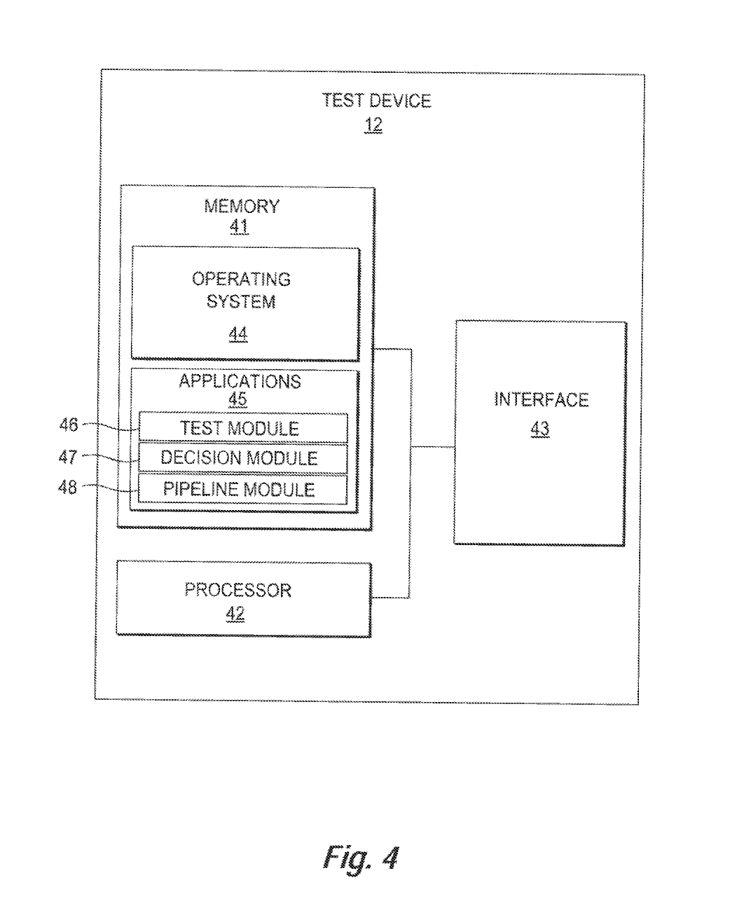

FIG. 4 illustrates a block diagram of a computer readable medium useable with the system 200 of FIG. 2 according to an example. In FIG. 4, the test device 12 is illustrated to include a memory 41, a processor 42, and an interface 43. The processor 42 represents generally any processor configured to execute program instructions stored in memory 41 to perform various specified functions. The interface 43 represents generally any interface enabling the test device 12 to communicate with the deployment device 14 via the link 10, as illustrated in FIGS. 1 and 3.

The memory 41 is illustrated to include an operating system 44 and applications 45. The operating system 44 represents a collection of programs that when executed by the processor 42 serve as a platform on which applications 45 may run. Examples of operating systems 43 include various versions of Microsoft's Windows® and Linux®. Applications 45 represent program instructions that when executed by the processor 42 function as an application that identifies a failed code change. For example, FIG. 4 illustrates a test module 46, a decision module 47, and a pipeline module 48 as executable program instructions stored in memory 41 of the test device 12.

Referring back to FIGS. 2-3, the test engine 22, the decision engine 24, and the pipeline engine 32 are described as combinations of hardware and/or programming. As illustrated in FIG. 4, the hardware portions may include the processor 42. The programming portions may include the operating system 44, applications 45, and/or combinations thereof. For example, the test module 46 represents program instructions that when executed by a processor 42 cause the implementation of the of the test engine 22 of FIGS. 2-3. The decision module 47 represents program instructions that when executed by a processor 42 cause the implementation of the of the decision engine 24 of FIGS. 2-3. The pipeline module 48 represents program instructions that when executed by a processor 42 cause the implementation of the of the pipeline engine 32 of FIG. 3.

The programming of the test module 46, decision module 47, and pipeline module 48 may be processor executable instructions stored on a memory 41 that includes a tangible memory media and the hardware may include a processor 42 to execute the instructions. The memory 41 may store program instructions that when executed by the processor 42 cause the processor 42 to perform the program instructions. The memory 41 may be integrated in the same device as the processor 42 or it may be separate but accessible to that device and processor 42.

In some examples, the program instructions may be part of an installation package that can be executed by the processor 42 to perform a method using the system 200. The memory 41 may be a portable medium such as a CD, DVD, or flash drive or a memory maintained by a server from which the installation package can be downloaded and installed. In some examples, the program instructions may be part of an application or applications already installed on the server. In further examples, the memory 41 may include integrated memory, such as a hard drive.

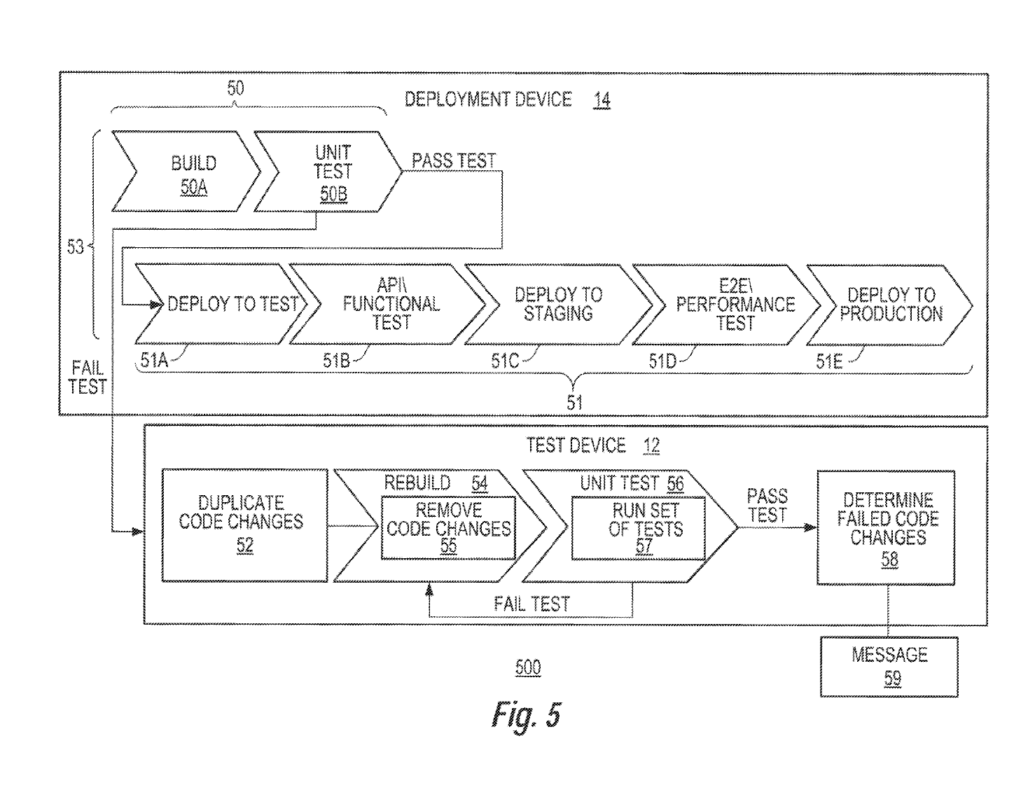

FIG. 5 illustrates a schematic diagram 500 of the process that identifies the failed code change according to an example. FIG. 5 illustrates the test device 12 and the deployment device 14. The deployment device 14 is divided into the continuous integration portion 50 and the continuous deployment portion 51. The continuous integration portion 50 includes a build 50A and unit test 50B step. The build 50A step creates an assembly including the code changes. The continuous deployment portion 51 performs the automated testing of the assemblies that determines when the assembly with the code change is ready to be released into production in a software application. For example, the continuous deployment portion 51 of a deployment pipeline 53 may deploy an assembly with a code change to production using the following steps: deploy to test 51A, application programming interface/functional test 51B, deploy to staging test 51C, end-to-end/performance test 51D and verification to deploy to production 51E.

Referring to the continuous integration portion 50, the integration of code changes into assemblies may be automated, which send the assembly to the continuous deployment portion 51 when the unit test 50B results indicate that the test or set of tests with the code changes are acceptable or pass the test. However, when the assembly does not pass the unit tests, the code change that causes the failure is determined using a manual and time consuming process. The test device 12 as illustrated may allow for automated identification of the code changes that result in a failure. For example, when the unit test 50B fails the test device 12 is initiated. The test device 12 then duplicates 52 the code changes in, for example the pipeline engine 32, from the deployment pipeline 53 in the deployment device 14. The assembly is rebuilt 54 with at least one of the code changes removed 55 from the assembly. The unit test 56 is performed by running 57 a set of tests that are the same or similar to the unit test 50B on the rebuilt 54 assembly. The assembly may be rebuilt and the unit tests performed in, for example, the test engine 22.

When the unit test 56 fails the assembly is rebuilt 54 with a different code change removed 55 and the unit test 56 is performed again. The rebuilding 54 and unit testing 56 repeats or continues until the assembly passes the set of tests 57 in the unit test 56, The failed code change is then determined 58 based on the code changes in the assembly that pass the set of tests 57. For example, a decision engine 24 may compare the code changes in the assembly that passed the set of tests to the code changes in the last assembly that failed the set of tests. The failed code change may then be automatically transmitted as a message 59 to the developer and/or an administrator. The detection 58 of the failed code change identifies a single code change and/or a group or plurality of code changes that contain at least one failed code change.

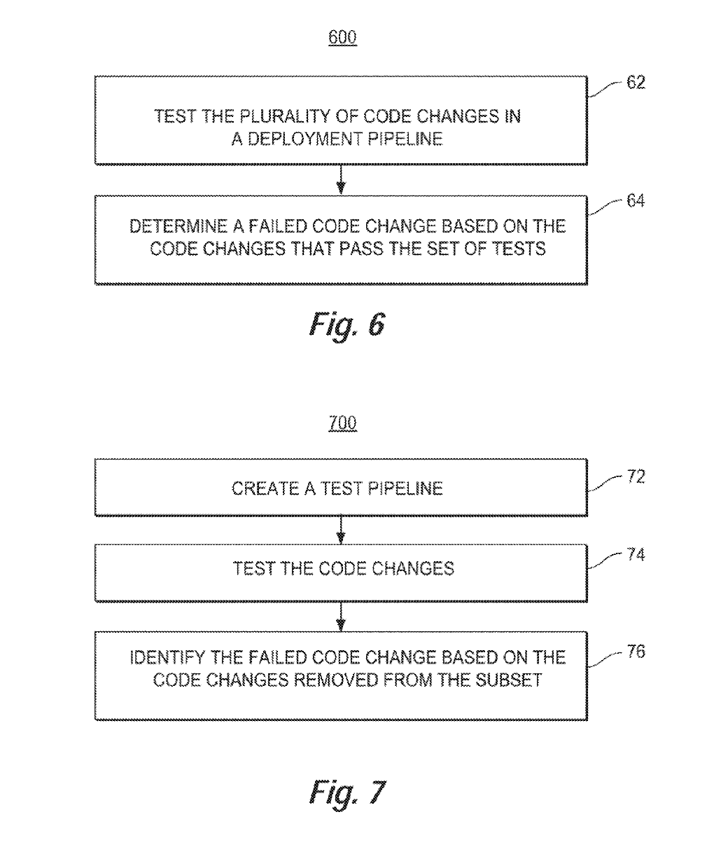

FIG. 6 illustrates a flow diagram 600 of a method, such as a processor implemented method to identify a failed code change in a deployment pipeline with a plurality of code changes according to an example. In block 62, the plurality of code changes in the deployment pipeline are tested in an application under test environment, in for example, the test engine. The testing includes a set of tests being run on the plurality of code changes until a subset of the plurality of code changes pass the set of tests. The testing further includes removal of at least one of the plurality of code changes from the subset each time the subset fails the set of tests.

The at least one of the plurality of code changes removed may be selected based on a time that the at least one of the plurality code changes is deposited into a source configuration management tool. For example, each code change may receive a time stamp when it is submitted through the source configuration management tool and the data associated with the time stamp may be used by the pipeline engine to determine which code change is removed and/or provide identifying information, such as the developer who submitted the code change. Additional data may also be associated with each code change and may similarly be used to determine which code change is removed. Furthermore, a predetermined percentage of the plurality of code changes may be removed from the subset until the subset passes the set of tests. For example, the subset may be divided in half until the subset passes the set of test. In the example, if one-half of the code changes are removed from the subset three times during testing, the subset is as follows: test 1) all code changes, test 2) one-half of the code changes, test 3) one-quarter of the code changes, and test 4) one-eighth of the code changes in the subset by the time the subset passes the set of tests.

The failed code change is determined in block 64 based on the subset that passes the set of tests. The decision engine may make the determination and identify the failed code change. The determination of the failed code change may include identification of the at least one of the plurality of code changes removed from the subset. The determination of the failed code change may also include a comparison of the at least one of the plurality of code changes in the subset that pass the set of tests to the at least one of the plurality of code changes in the subset that fail the set of tests. Referring back to the example where one-half of the code changes are removed each time the subset fails the unit test, an automated determination that the failed code change is in the one-eighth of the code changes removed between tests 3 and 4. Using the automated determination during continuous integration saves time and resources.

The method may also duplicate the plurality of code changes in the deployment pipeline to create the subset. Moreover, the plurality of code change may be duplicated to create a plurality of parallel test subsets, with each of the plurality of parallel test subsets having a distinct permutation of the plurality of code changes. The plurality of parallel test subsets may be tested simultaneously to determine which of the plurality of parallel test subsets pass the set of tests. The plurality of parallel test subsets that pass the set of tests are then compared to determine the failed code change.

FIG. 7 illustrates a flow diagram 700 of a method, such as a processor implemented method, to identify a failed code change in a deployment pipeline with a plurality of code changes. For example, the method may be instructions stored on a computer readable medium that, when executed by a processor, cause the processor to perform the method. In block 72, a subset of the plurality of code changes is created in the deployment pipeline, for example in a deployment engine. The subset is tested in block 74. For example, the testing may be performed by a test device that runs a set of tests on the subset, and removes the at least one of the plurality of code changes from the subset until the subset passes the set of tests. The failed code change is identified in block 76. The failed code change is identified based on the at least one of the plurality of code changes removed from the subset.

FIGS. 1-7 aid in illustrating the architecture, functionality, and operation according to examples. The examples illustrate various physical and logical components. The various components illustrated are defined at least in part as programs, programming, or program instructions. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Examples can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 6-7 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A computer implemented method to identify a failed code change in a deployment pipeline with a plurality of code changes, the method comprising:
testing the plurality of code changes in the deployment pipeline in an application under test environment, testing includes:
running a set of tests on the plurality of code changes until a subset of the plurality of code changes pass the set of tests, and
removing at least one of the plurality of code changes from the subset each time the subset fails the set of tests; and
determining the failed code change based on the subset that passes the set of tests.

2. The method of claim 1, wherein determining the failed code change comprises identifying the at least one of the plurality of code changes removed from the subset.

3. The method of claim 1, wherein determining the failed code change comprises comparing the at least one of the plurality of code changes in the subset that pass the set of tests to the at least one of the plurality of code changes in the subset that fail the set of tests.

4. The method of claim 1, wherein removing at least one of the plurality of code changes further comprises selecting the at least one of the plurality of code changes to remove based on a time that the at least one of the plurality code changes is deposited into a source configuration management tool.

5. The method of claim 1, wherein removing at least one of the plurality of code changes further comprises removing a predetermined percentage of the plurality of code changes from the subset until the subset passes the set of tests.

6. The method of claim 1, further comprising duplicating at least one of the plurality of code changes in the deployment pipeline to create the subset.

7. The method of claim 1, further comprising creating a plurality of parallel test subsets from the plurality of code changes in the deployment pipeline, each of the plurality of parallel test subsets include a distinct permutation of the plurality of code changes.

8. The method of claim 7, wherein testing the plurality of code changes further comprises:
testing each of the plurality of parallel test subsets simultaneously to determine which of the plurality of parallel test subsets pass the set of tests; and
comparing the plurality of parallel test subsets that pass the set of tests to determine the failed code change.

9. A system to identify a failed code change in a deployment pipeline with a plurality of code changes, the system comprising:
a test engine to perform a set of tests on a subset of the plurality of code changes in the deployment pipeline; and
a decision engine to:
instruct the test engine to perform the set of tests,
remove at least one of the plurality of code changes from the subset of the plurality of code changes until the subset passes the set of tests, and
determine the failed code change based on the at least one code change removed from the subset that passes the set of tests.

10. The system of claim 9, wherein the decision engine determines the failed code by comparing the at least one code change contained in the subset that passes the set of tests and the at least one code change contained the subset that fails the set of tests when the subset fails the set of tests prior to passing the set of tests.

11. The system of claim 9. further comprising a pipeline engine to remove the at least one of the plurality of code changes from the subset.

12. The system of claim 11, wherein the pipeline engine creates a plurality of parallel test subsets from the plurality of code changes, each of the plurality of parallel test subsets include a distinct permutation of the plurality of code changes.

13. The system of claim 12, wherein the test engine tests each of the plurality of parallel test subsets simultaneously to determine which of the plurality of parallel test subsets pass the set of tests.

14. The system of claim 9, wherein the decision engine automatically transmits a message identifying the failed code change.

15. A computer readable medium having stored thereon instructions that, when executed by a processor, cause the processor to perform a method to identify a failed code change in a deployment pipeline with a plurality of code changes, the method comprising:
creating a subset of the plurality of code changes in the deployment pipeline;
testing the subset, wherein testing includes:
running a set of tests on the subset, and
removing the at least one of the plurality of code changes from the subset until the subset passes the set of tests; and
identifying the failed code change based on the at least one of the plurality of code changes removed from the subset.
